(19) United States
(12) Patent Application Publication
(10) Pub. No.: US 2011/0005555 A1
(43) Pub. Date: Jan. 13, 2011

(54) WORK WASHING APPARATUS

(76) Inventor: Keiji Kataoka, Aichi-ken (JP)

Correspondence Address: CLARK & BRODY, 1700 Diagonal Road, Suite 510, Alexandria, VA, 22314, US

(21) Appl. No.: 12/652,085

(22) Filed: Jan. 5, 2010

(30) Foreign Application Priority Data
Jul. 9, 2009 (JP) 2009-162963

(51) Int. Cl. B08B 3/00

(52) U.S. Cl. 134/137

(57) ABSTRACT

A conventional invention has a structure of a washing chamber in which the work is set on a table and the entire surface of the work is consistently washed and dried by rotations in an orbital motion and a planetary motion of the washing and drying nozzles which are respectively provided in all four directions—top, bottom, right and left. The conventional invention effectively washes a greater area of the work or the like, but due to limitations of the structure, it can wash only small-sized works or small components. Also, it does not always sufficiently wash and dry large-sized works, and consequently overhaul such works.

To resolve the problems, besides the above structures, the present invention provides an additional structure of a rotary frame to generate rotations in an orbital motion and planetary motion so that the works can be efficiently and entirely washed and dried, and the overhaul of the works can consequently be completed.

### FIELD OF THE INVENTION

This invention relates to a washing apparatus for washing large-sized works such as frames, works or the like for NC (numerical control) lathe or the like to be used for cutting work, then for overhauling the frames, works or the like, or for washing and overhauling a wheel base, chassis or the like.

### BACKGROUND OF THE INVENTION

Conventional methods or apparatuses for washing general-shaped or generalsized works have a structure with multiple nozzles for water and air, of which the washing/drying points are properly set so as to efficiently wash and dry the works. Thus, in necessarily providing multiple nozzles, the washing apparatus or the like, for example, becomes complicated and larger, which makes other problems such that the piping and maintenance work becomes complicated or the like. The following prior art documents include examples to resolve such problems.

Patent Document 1 is a Japanese Published Unexamined Application No. 560-102990 entitled “Washing Apparatus” referring to the invention characterized by comprising a structure with a turntable provided in a washing chamber, a table for components to be placed thereon, and multiple washing nozzles provided in three directions in the chamber. Thus, the washing operation is automatized and accelerated. However, the nozzles of this invention are set to wash the work within the rage of approx. 80 degrees only, so that the washing range is limited and thus unsuitable for washing large-sized work. Thus, further improvement is required.

Patent Document 2 is a Japanese Published Unexamined Application No. H03-221177 entitled “Washing and Drying Apparatus in the Air” referring to the invention characterized by comprising an apparatus incorporating a washing chamber therein the work being set in the air is washed and dried from four directions by the rotating washing and drying nozzles with a control mechanism. Thus, the washing operation is automatized and accelerated. However, the multiple nozzles in this invention simply wash and dry the work so that the washing range is limited and thus unsuitable for washing large-sized work. Thus further improvement is required.

Patent Document 3 is a Japanese Published Unexamined Application No. H06-226220 entitled “Washing Apparatus” referring to the invention characterized by comprising a pair of nozzles which rotate like the sun-and-planet motion in a horizontal direction by using supporting arms so as to sprinkle cleaning liquid and/or hot water and to efficiently and beautifully wash a component, i.e. a hopper or the like used as metering equipment by using a limited number of nozzles. However, the structure using the rotations of the orbital motion and planetary motion described in the specification can wash and dry only small components or small parts of a component. Thus, the industrial application is still limited.

Patent Document 4 is a Japanese Published Unexamined Application No. 2002-126663 entitled “Work Washing Method and the Apparatus” referring to the invention characterized by comprising a washing chamber therein the work is set on a table, and washed entirely in one operation by top and bottom surface washing/drying nozzles and the right and left side surface washing/drying nozzles by their respective planetary and orbital rotations, which enables the apparatus to widely and efficiently wash and dry the work. This invention has a structure in which top surface washing/drying nozzles are provided on the main shaft axially provided on the frame and right and left side surface washing/drying nozzles provided on the rotary plate mounted on both the main shaft and the support rods mounted on the rotary plate. Thus, this invention can be used for washing a small work and/or small components. However, it is not always suitable for washing a large-sized work and/or overhauling such work.

[Patent Document 1] Japanese Published Unexamined Application No. S60-102990
[Patent Document 2] Japanese Published Unexamined Application No. H03-221177
[Patent Document 3] Japanese Published Unexamined Application No. H06-226220

### [Patent Document 4] Japanese Published Unexamined Application No. 2002-126663

### SUMMARY OF THE INVENTION

### Problems to be resolved by the invention

The aforementioned Documents 1 to 4 are specifically used for small-sized work. Thus, none of them can be used for washing large-sized work which is desired in the current invention. One of the reasons, for example, is that in order to wash any large-sized work, a top surface washing device and side surface washing devices must also be large. It is thought that there is still technical difficulty in firmly supporting and revolving such a large top surface washing device and large side surface washing devices. And another reason, for example, is that the inventions of Documents 1 to 4 are not sufficiently designed to meet any conditions on which side surface washing devices can operate and support other various devices to rotate themselves. The other reason, for example, is that the above Documents 1 to 4 seem not to describe a desired structure to steadily supply and recycle water and air when required.

### Means to Resolve the Problems

The first invention of the present application is designed to sequentially and smoothly wash and dry any large-sized work from all directions by using numerous nozzles provided on a top surface washing device and on side surface washing devices mounted on the rotary frame of the main frame, together with multiple nozzles being provided on a bottom surface washing device, to wash and dry at least the top and side surfaces of any large-sized work by the steadily-rotating numerous nozzles provided on the top surface washing device and side surface washing devices, and to have a structure by which the rotation starting points of the numerous side surface nozzle links of the side surface washing devices, provided on the upper and lower portions of the right and left side washing devices rotate in bilateral crisscross way, so as to reduce the stress on the rotary frame, so as to steadily and smoothly revolve the rotary frame, and so as to steadily and smoothly rotate the side surface nozzle links themselves.

The first invention of the present application refers to a work washing apparatus characterized in comprising a process chamber incorporating a transferring device to carry work between a discharge position and a washing/drying position, wherein there are three different washing devices: a top surface washing device with top surface nozzles for water and air, which rotate like the sun-and-planet motion created by orbital motion and planetary motion, two side surface washing devices with side surface nozzles for water and air, which rotate like the sun-and-planet motion using orbital motion created by the orbital motion of the top surface washing device, and a bottom surface washing device with bottom surface nozzles for water and air, which rotate like the sun-and-planet motion using planetary motion and orbital motion, so as to thoroughly wash and dry the work from all directions, the top surface washing device having; a U-shaped rotary frame suspended from the main shaft which is provided on a main frame so as to freely rotate, a drive means and a transmitting device to rotate the main shaft, a rotary structure for the rotation of the main shaft, rotary shafts which are axially supported by the rotary frame supporting gears of the rotary structure and the top surface nozzle links with a pair of nozzles provided on the rotary shafts, thereby the rotational action of the main shaft makes the rotary frame gyrate thus causing the rotary shafts to rotate, thence making the top surface nozzle links themselves rotate, the side surface washing devices having: a pair of side surface nozzle links axially supported on either side of the U-shaped rotary frame, a pair of nozzles provided on each side surface nozzle link, a pulley provided on the axis of each side surface nozzle link, two horizontal shafts above the rotary frame engaged to gears engaged to the rotary shafts of the side surface washing devices, a pulley provided at either outer end of the horizontal shafts and a belt provided on each said pulleys, thereby the rotational action of the gyrating U-shaped rotary frame to the side surface rotary shafts is transmitted by the two horizontal shafts to each gear by the pulley provided on either outer end of the two horizontal shafts, thence to the pulleys provided on the axis of the side surface nozzle links, thus making the side surface nozzle links themselves rotate, the bottom surface washing device having; a vertical shaft provided on the main frame, a rotary means for controlling the rotation of the vertical shaft, rotary plates provided on the vertical shaft, rotary shafts provided on the rotary plate, bottom surface nozzle links incorporating the bottom surface nozzles and a rotary mechanism for controlling the rotation of the rotary shafts, thereby the rotational action of the vertical shafts is transmitted to the rotary plate, thence through the vertical shafts by the rotary mechanism, thus making the bottom surface nozzle links themselves rotate.

The second invention of the present application is designed to achieve the objective of the first invention, thereby water and air are steadily supplied, and the pipes for supplying such water and air will not hinder the operation of the top surface washing device and the side surface washing devices so that each pipe is properly housed without damage.

The second invention refers to a work washing apparatus of claim 1 characterized in comprising a means for supplying water and air to each of the nozzles, the means having; a pump and/or a compressor, pipes extending from the pump and/or the compressor, and a main pipe being provided within the main shaft and connected to the pipes, branch pipes being connected to the main pipe by the branch joints externally provided outside of the rotary frame, a first and second connecting pipe connected to the branch pipe by the branch joints within each rotary shaft, top surface nozzles provided at the end of the first and second connecting pipes, a third and fourth connecting pipe connected to the branch pipe by the branch joints within the rotary frame, side surface nozzles provided at the ends of the third and the fourth connecting pipes, the branch pipes extending from the pump, a fifth and sixth connecting pipe connected to the branch pipe by the branch joints within the vertical shaft and bottom surface nozzles provided at the end of the fifth and the sixth connecting pipes.

### EFFECT OF THE INVENTION

The first invention of the present application refers to a work washing apparatus characterized in comprising a process chamber incorporating a transferring device to carry work between a discharge position and a washing/drying position, wherein there are three different washing devices: a top surface washing device with top surface nozzles for water and air, which rotate like the sun-and-planet motion created by orbital motion and planetary motion, two side surface washing devices with side surface nozzles for water and air, which rotate like the sun-and-planet motion using orbital motion created by the orbital motion of the top surface washing device, and a bottom surface washing device with bottom surface nozzles for water and air, which rotate like the sun-and-planet motion using planetary motion and orbital motion, so as to thoroughly wash and dry the work from all directions, the top surface washing device having; a U-shaped rotary frame suspended from the main shaft which is provided on a main frame so as to freely rotate, a drive means and a transmitting device to rotate the main shaft, a rotary structure for the rotation of the main shaft, rotary shafts which are axially supported by the rotary frame supporting gears of the rotary structure and the top surface nozzle links with a pair of nozzles provided on the rotary shafts, thereby the rotational action of the main shaft makes the rotary frame gyrate thus causing the rotary shafts to rotate, thence making the top surface nozzle links themselves rotate, the side surface washing devices having: a pair of side surface nozzle links axially supported on either side of the U-shaped rotary frame, a pair of nozzles provided on each side surface nozzle link, a pulley provided on the axis of each side surface nozzle link, two horizontal shafts above the rotary frame engaged to gears engaged to the rotary shafts of the side surface washing devices, a pulley provided at either outer end of the horizontal shafts and a belt provided on each said pulleys, thereby the rotational action of the gyrating U-shaped rotary frame to the side surface rotary shafts is transmitted by the two horizontal shafts to each gear by the pulley provided on either outer end of the two horizontal shafts, thence to the pulleys provided on the axis of the side surface nozzle links, thus making the side surface nozzle links themselves rotate, the bottom surface washing device having; a vertical shaft provided on the main frame, a rotary means for controlling the rotation of the vertical shaft, rotary plates provided on the vertical shaft, rotary shafts provided on the rotary plate, bottom surface nozzle links incorporating the bottom surface nozzles and a rotary mechanism for controlling the rotation of the rotary shafts, thereby the rotational action of the vertical shafts is transmitted to the rotary plate, thence through the vertical shafts by the rotary mechanism, thus making the bottom surface nozzle links themselves rotate.

Therefore, the first invention of the present application has the advantage of being able to sequentially and smoothly wash and dry any large-sized work from all directions by using numerous nozzles provided on a top surface washing device and side surface washing devices mounted on the rotary frame of the main frame, together with the multiple nozzles being provided on a bottom surface washing device, to wash and dry at least the top and side surfaces of any large-sized work by the steadily-rotating numerous nozzles provided on the top surface washing device and side surface washing devices, and to have a structure by which the rotation starting points of the numerous side surface nozzle links of the side surface washing devices provided on the upper and lower portions of the right and left side washing devices, rotate in a bilateral crisscross way so as to reduce stress on the rotary frame, so as to steadily and smoothly revolve the rotary frame, and so as to steadily and smoothly rotate the side surface nozzle links themselves.

The second invention refers to a work washing apparatus of claim 1 characterized in comprising a means for supplying water and air to each of the nozzles, the means having; a pump and/or a compressor, pipes extending from the pump and/or the compressor, and a main pipe being provided within the main shaft and connected to the pipes, branch pipes being connected to the main pipe by the branch joints externally provided outside of the rotary frame, a first and second connecting pipe connected to the branch pipe by the branch joints within each rotary shaft, top surface nozzles provided at the end of the first and second connecting pipes, a third and fourth connecting pipe connected to the branch pipe by the branch joints within the rotary frame, side surface nozzles provided at the ends of the third and the fourth connecting pipes, the branch pipes extending from the pump, a fifth and sixth connecting pipe connected to the branch pipe by the branch joints within the vertical shaft and bottom surface nozzles provided at the end of the fifth and the sixth connecting pipes.

Therefore, the second invention of the present application has the advantage of being able to achieve the objective of the first invention, thereby water and air are steadily supplied, and the pipes for supplying such water and air will not hinder the operation of the top surface washing device and side surface washing devices so that each pipe is properly housed without damage.

### BRIEF DESCRIPTION OF THE DRAWINGS

FIG. 1 is a reduced drawing showing entirely the top view of the invention.

FIG. 2 is a reduced drawing showing entirely the side view of the invention.

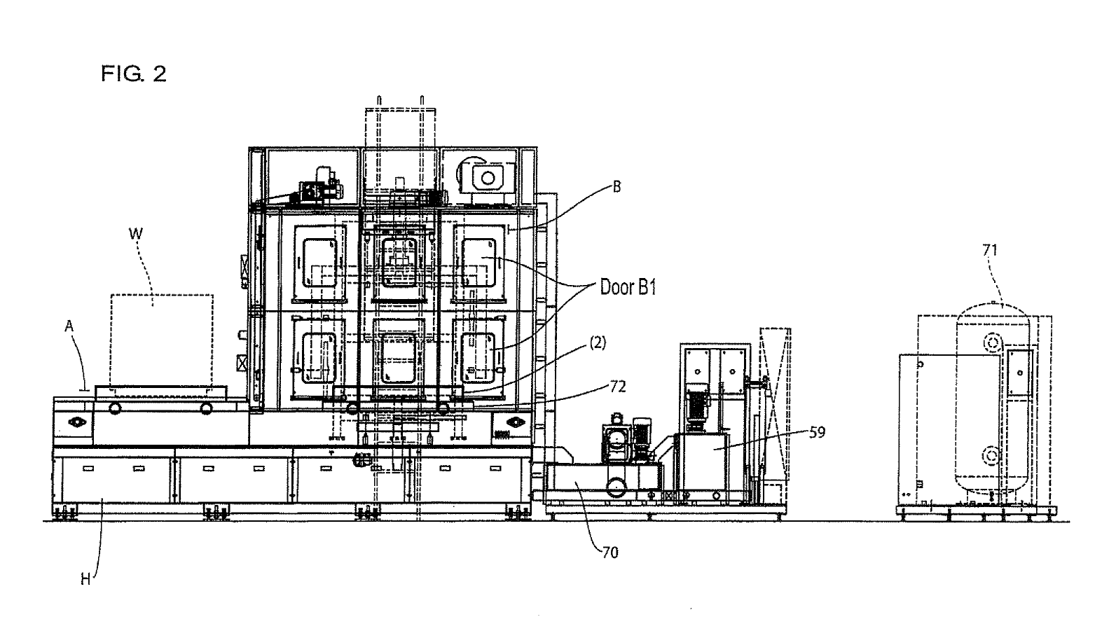

FIG. 3 is a schematic diagram showing the front view of the structure comprising the top, bottom and side washing devices of the invention.

FIG. 4 is a schematic diagram showing the overhead view of the rotary frame comprising the top surface washing devices of the invention.

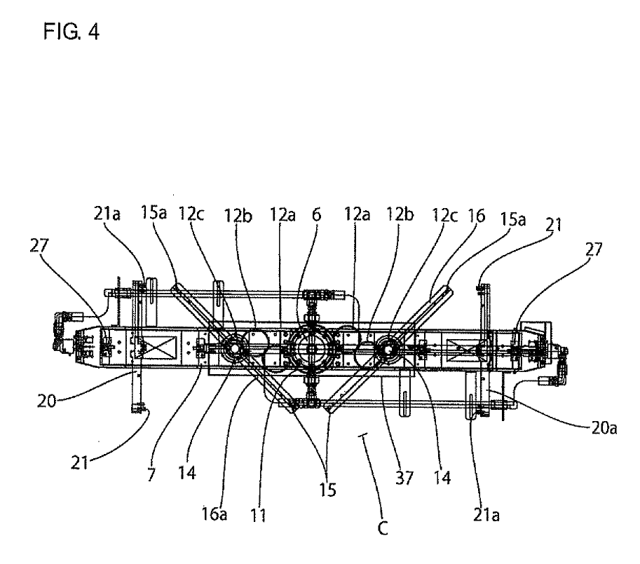

FIG. 5 is a schematic diagram showing the side view of the rotary frame comprising the side surface washing devices of the invention.

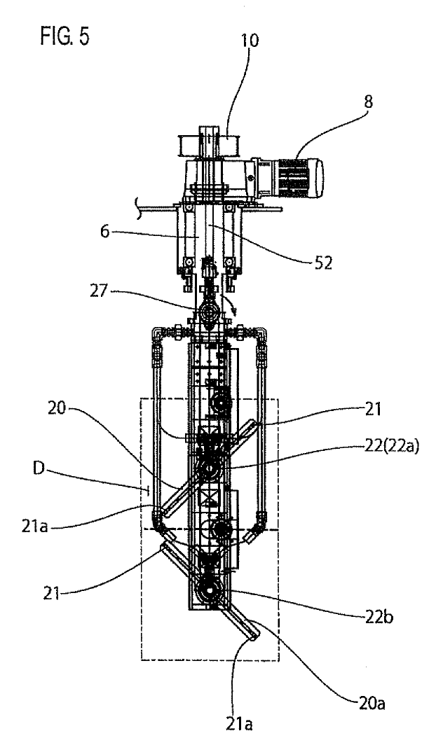

FIG. 6 is a schematic diagram showing the front view of the bottom surface washing device of the invention.

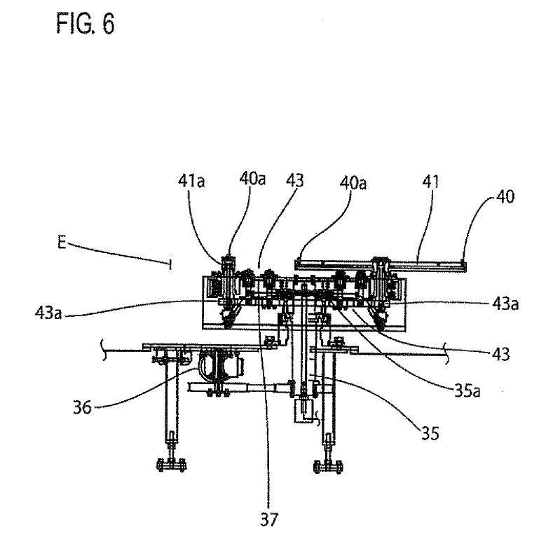

FIG. 7 is a schematic diagram showing the overhead view of the bottom surface washing device of the invention.

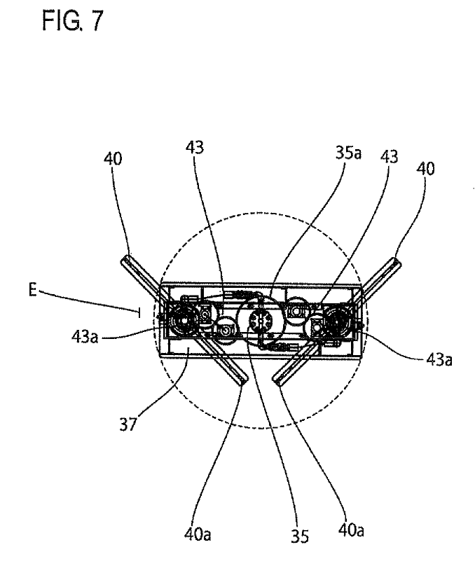

FIG. 8 is a reduced schematic diagram showing the water flow path of the invention.

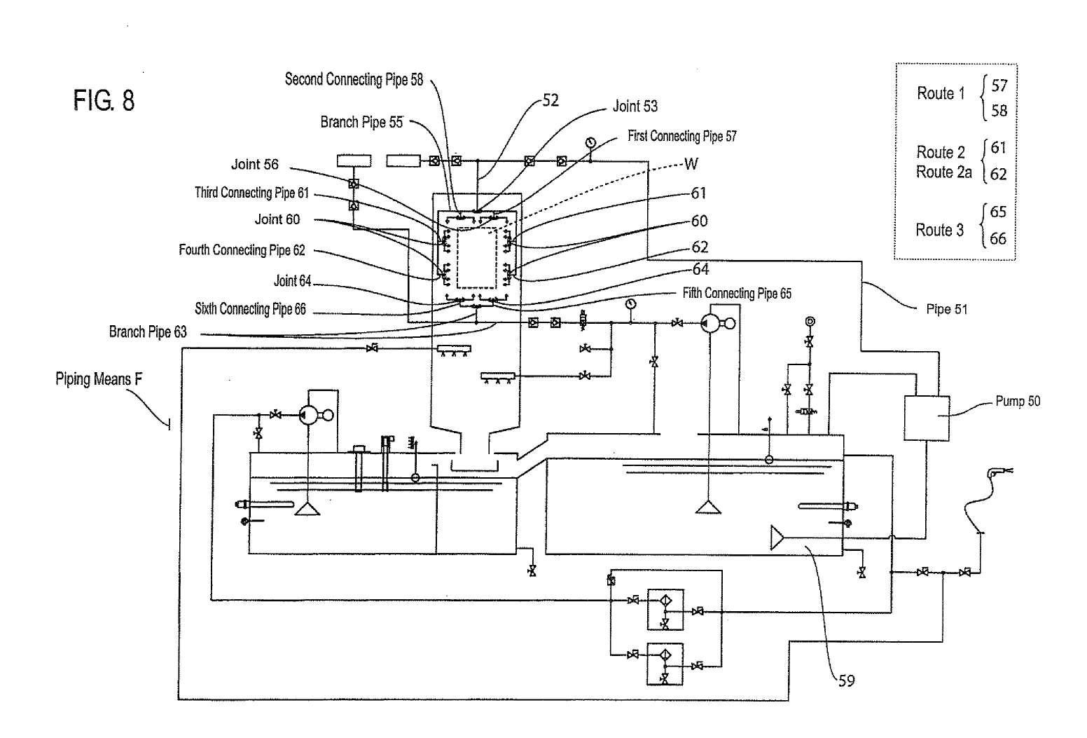

FIG. 9 is a reduced schematic diagram showing the airflow path of the invention.

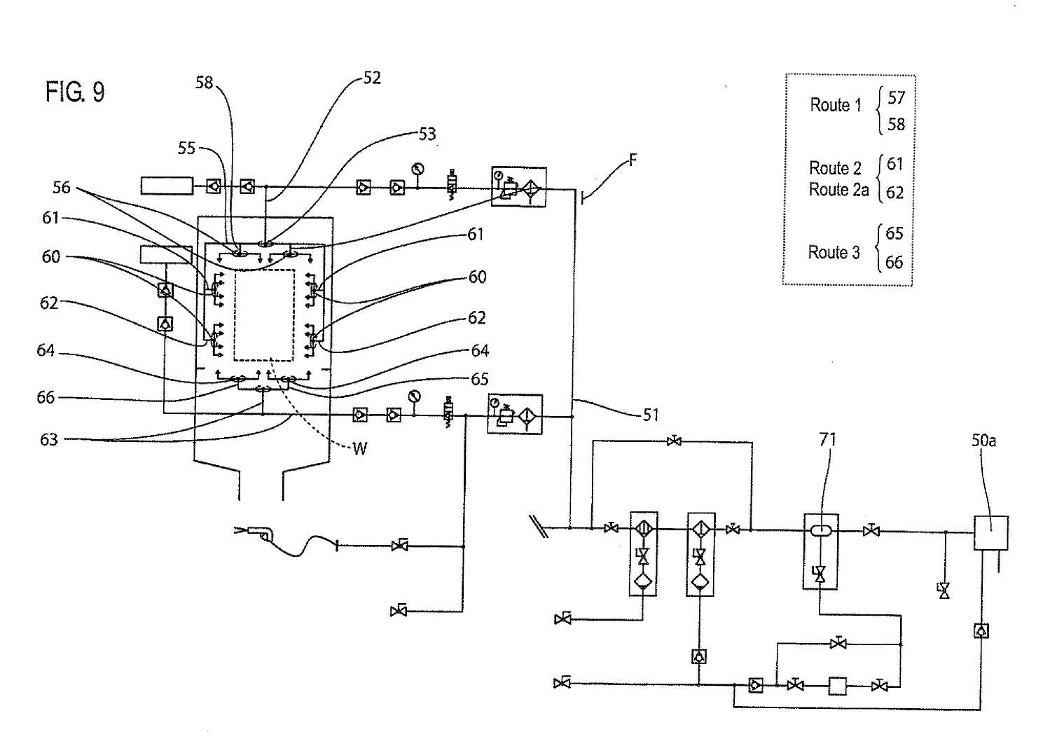

### DESCRIPTION OF THE PREFERRED EMBODIMENT

The main constituent elements of this invention are the work washing units comprising a transferring device A for controlling forward and backward movements of the work W, a process chamber B, incorporating the transferring device A to wash and dry the large-sized work W (hereinafter referred to as the work W) by using water and air; and other devices provided in the process chamber B such as the top surface washing device C mounted on the top surface of the process chamber B and having nozzles making planetary movements by utilizing the rotations thereof on their own axes and orbital movements thereof; and side surface washing devices D, D (a description of one will be given) provided on either side surface of the transferring device A and having nozzles which make planetary movements by utilizing the rotations thereof on their own axes and orbital movements thereof; and a bottom surface washing device E provided on the bottom surface of the transferring device A and having nozzles which make planetary movements by utilizing rotations of the nozzles on their own axes and orbital movements thereof; together with a piping means F for supplying and spraying water or the like through nozzles. The process chamber B comprises numerous doors B1.

The transferring device A moves forward and backward by a chain 1 attached to a gear (not shown in the drawing), with the table 2 and a motor (not shown in the drawing) to drive the chain 1. The work is set on the table 2. The chain 1 extends to the process chamber B. To stop the chain 1 from either moving forward or backward, an electrical means (not shown in the drawing) such as a limit switch, a relay or the like is used.

Each device internally provided in the process chamber B is hereby described.

The top surface washing device C includes a rotatable main shaft 6 provided on the frame 5 of the process chamber B; a U-shaped rotary frame 7 suspended from the main shaft 6 (and rotating with the main shaft 6); a motor 8 (drive means) provided on the frame 5 to rotate the main shaft, and a transmitting device 10 (comprising pulleys and a belt structure on the output axes of the main shaft 6 and the motor 8); a gear 11 provided on the lower end of the main shaft 6; a pair of gears 12a (only one pair is described since each structure is identical) mounted axially vertically on the frame 5 and engaged to the gear 11; an intermediate gear 12b engaged to gear 12a; a rotary shaft 14 axially supported by the rotary frame 7 which supports the gear 12c engaged to the intermediate gear 12b; the top surface nozzle links 16, 16a mounted on the rotary shaft 14 and having top surface nozzles 15, 15a (at either end of the nozzle links). Accordingly, the orbital movements of the top surface nozzles 15 are done in a described path extending from the motor 8 to the transmitting device 10 to the main shaft 6 to the rotary frame 7. The rotational movements of the top surface nozzles 15 (of the top surface nozzle links 16) on their own axes begin from the motor 8 to the transmitting device 10 to the main shaft 6 to the gears 12a to 12c to the rotary shafts 14. In this structure, the top surface of the work W is washed and dried by the orbital and axial movements of the top surface nozzles 15. The gears 11, 12a to 12c cause the washing/drying structures to rotate, with the gear 12c being provided on each rotary shaft 14.

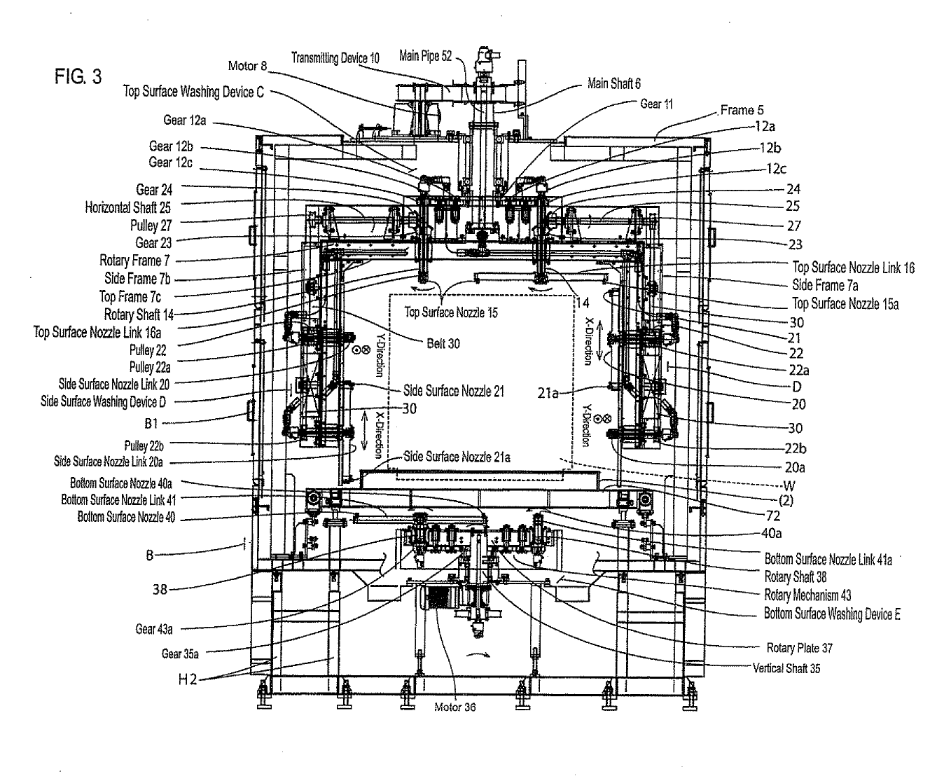

The side surface washing devices D,D (a description of one will be given) include the upper and lower nozzle links 20, 20a which are axially provided on the side frames 7a, 7b of the rotary frame 7 with the upper and lower nozzles 21, 21a and the pulleys 22, 22a, 22b which are axially provided on the nozzle links 20, 20a with the horizontal shaft 25 having a gear 24 at one end engaged to a gear 23 provided on each rotary shaft 14 which are provided on the rotary frame 7 with a pulley 27 being provided at the outer end of the horizontal shaft 25 and the belts 30 connecting the pulley 27 to the pulley 22 or to the pulley 22a or the pulley 22b, respectively. Thus, the orbital movements of the side surface nozzles 21, 21a (of the side surface nozzle links 20, 20a) are made in accordance with the rotating motion of the rotary frame 7. The rotational movements of the side surface nozzles 21, 21a on their own axes are made by the horizontal shaft 25 thence to the rotary means comprising the pulley 27, 22 to 22b and the belt 30. The side surface washing device D has a structure to wash and dry the entire side surface of the work W by the orbital and axial movements of the side surface nozzles 21, 21a. As shown in FIG. 3, the side surface washing device D has a structure in which the rotating starting points (the stop point and movable point) of the side surface nozzle links 20, 20a provided on the upper and lower portions of each side surface washing device D rotate in a bilateral crisscross way (in an X to Y direction on the right side as shown in FIG. 3, and in a Y to X direction on the left side as shown in FIG. 3) so as to keep each load of the two side surface washing devices D in balance, in order to reduce the stress on the rotary frame 7 and on the motor 8 or the like, and to allow a steady and smooth rotation of the rotary frame 7 and a steady and smooth rotation of the side surface nozzle links 20, 20a themselves. The rotation starting points of the side surface nozzle links 20, 20a control their axial movements as well as the movements of the pulleys 22, 22a, 22b or the like by a control device which is not shown.

The bottom surface washing device E includes a rotatable vertical shaft 35 provided on the frame 5; a motor 36 (rotary means) to rotate the vertical shaft 35; a rotary plate 37 provided on the vertical shaft 35; rotary shafts 38 provided on the rotary plate 37; a pair of bottom surface nozzle links 41, 41a each with a pair of nozzles 40, 40a; a rotary mechanism 43 to rotate the rotary shafts 38; the gear 43a engaged to the first gear of the rotary mechanism 43 and to the gear 35a of the vertical shaft 35. Thus, the orbital movements of the bottom surface nozzles 40, 40a (at either end of the bottom surface nozzle links 41, 41a) are made by the motor 36 through the vertical shaft 35 to the bottom surface nozzle links 40, 40a. The rotational movements of the bottom surface nozzles 40, 40a (at either end of the bottom surface nozzle links 41, 41a) on their own axes are made by the motor 36 thence through the vertical shaft 35 through the gear 35a of the vertical shaft 35 through the rotary mechanism 43 to the rotary shafts 38. The bottom surface washing device has a structure to wash and dry the bottom surface of the work W by the orbital and axial movements of the bottom surface nozzles 40, 40a.

As described above, the present application has a structure in which the U-shaped frame 7 is suspended from the main shaft 6 which is provided on the frame 5 of the process chamber B. The top surface nozzle links 16, 16a are provided on the top frame 7c of the rotary frame 7, and the side surface nozzle links 20, 20a are provided on the side frames 7a, 7b with a large space existing between the top surface nozzle links 16, 16a and the side surface nozzle links 20, 20a. The orbital movements of the top surface nozzle links 16, 16a and of the side surface nozzle links 20, 20a are made by the rotating action of the rotary frame 7 so as to efficiently wash and dry the large-sized work W.

A piping means F provided for supplying and injecting water and air, into the process chamber B is hereby described. The piping means F for providing water and air for this work washing apparatus is activated by a water pump 50/air compressor 50a with the pipe 51 being connected to the water pump 50/air compressor 50a through numerous control devices. The piping means F consists of three routes: route 1 for the top surface nozzles 15, 15a; route 2 and 2a for the pairs of side surface nozzles 21, 21a, and route 3 for the bottom surface nozzles 40, 40a. The wastewater is processed and reused so as to achieve almost complete reusable recycling.

Route 1 for the top surface nozzles 15, 15a has a structure comprising the branch pipe 55 extending from the main pipe 52 provided within the main shaft 6 and another branch pipe 55 provided outside of the rotary frame 7 and connected to the main pipe 52 by the branch joint 53 provided outside of the rotary frame 7, to the rotary shafts 14, 14 (a description of one rotary shaft shall be given), and to the first connecting pipe 57 and second connecting pipe 58 provided within the top surface nozzle links 16 and 16a, respectively, and thence to the top surface nozzles 15, 15a provided at the ends of the first and second connecting pipes 57, 58. Thus, in this piping system, water flows from the tank 50 through the main pipe 52 through the branch pipe 55 through the first and second connecting pipes 57, 58 to the top surface nozzles 15, 15a. The main pipe 52 is provided within the main shaft 6, and the first and second connecting pipes 57, 58 are provided within the rotary shafts 14, 14 and the top surface nozzle links 16, 16a, so as to correspond to the orbital rotations of the rotary frame 7 (with the top surface nozzle links 16, 16a) and to the axial rotations of the top surface nozzle links 16, 16a, thus enabling the apparatus to be simplified and reducing mechanical breakdown or the like.

Routes 2, 2a for the side surface nozzles 21, 21a have a structure comprising the third and fourth connecting pipes 61, 62 which are connected to the branch pipe 55 by the branch joint 60 and extending within the rotary frame 7 and then outside the rotary frame 7 and then into the side surface nozzle links 20, 20a and thence to the side surface nozzles 21, 21a provided at the ends of the third and fourth connecting pipes 61, 62. Thus, in this piping system, water flows from the branch pipe 55 through the third and fourth connecting pipes 61, 62 to the side surface nozzles 21, 21a. The third and fourth connecting pipes 61, 62 are provided within the rotary frame 7 and the side surface nozzle links 20, 20a so as to correspond to the orbital rotations of the rotary frame 7 (with the side surface nozzle links 20, 20a) and to the axial rotations of the side surface nozzle links 20, 20a, thus enabling the apparatus to be simplified and reducing mechanical breakdown or the like. The third and fourth connecting pipes 61, 62 are provided on the right and left sides of the side surface washing device D, and its water flow is described here.

Route 3 for the bottom surface nozzles 40, 40a has a structure comprising a branch pipe 63 which is connected to the pipe 51 extending from the provided on a pump 50, and the fifth and sixth connecting pipes 65, 66 extending from the branch pipe 63 within the vertical shaft 35 and connected by the branch joint 64 and thence extending to the bottom surface nozzle links 41, 41a and thence to the bottom surface nozzles 40, 40a provided at the ends of the fifth and sixth connecting pipes 65, 66. Thus, in this piping system, water flows through the pipe 51 from the pump 50 through the branch pipe 63 through the fifth and sixth connecting pipes 65, 66 to the bottom surface nozzles 40, 40a. The fifth and sixth connecting pipes 65, 66 are provided within the vertical shaft 35 and the bottom surface nozzle links 41, 41a so as to correspond to the rotations of the rotary plate 37 and to the axial rotations of the bottom surface nozzle links 41, 41a, thus enabling the apparatus to be simplified and reducing mechanical breakdown or the like.

The aforementioned air flow is realized by using the same piping means F that is used for the water flow. The compressor 50 is used for the air flow. However, the switching mean for the water flow and the air flow is not shown in the drawings.

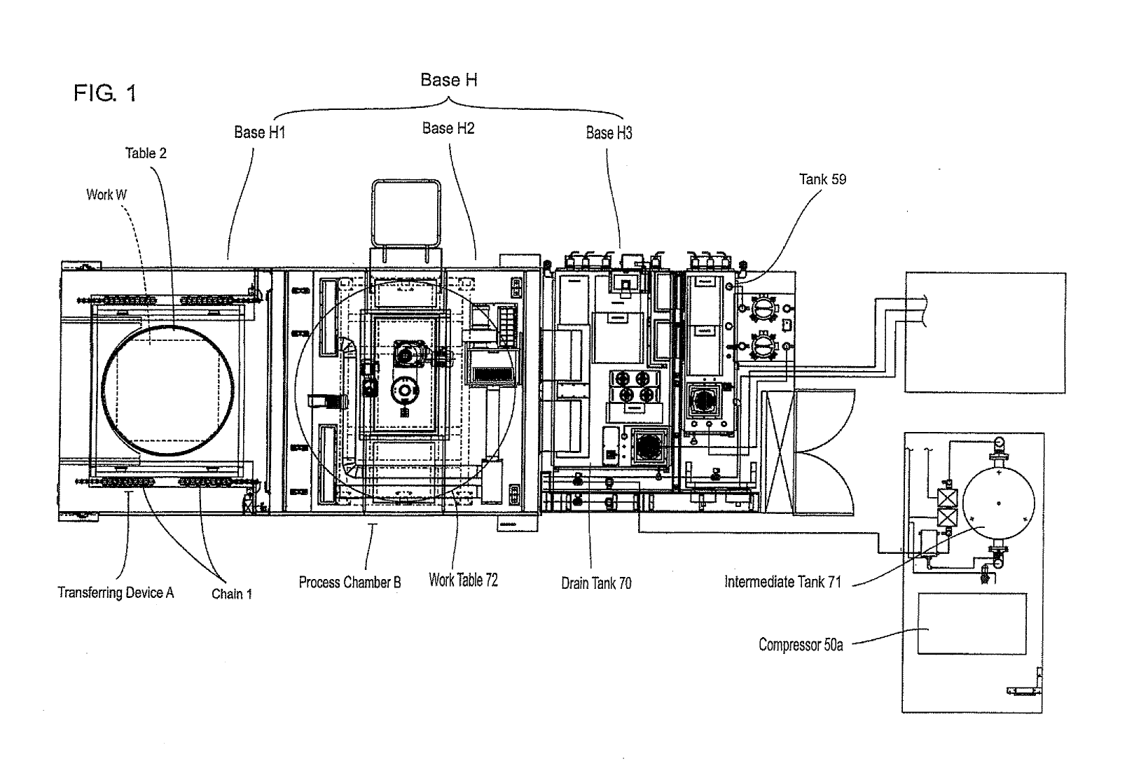

The drain tank 70 and intermediate tank 71 are shown in FIG. 1. The apparatus of this invention consists of base H1, bases H2 and base H3 of base H. Each base can be freely assembled or dismantled so that the entire apparatus can easily be loaded onto vehicles for transportation, thus simplifying any moving operation. There is a work table 72 provided inside the process chamber B with a clearance (not shown) between them to protect the apparatus from water or the like being injected from the bottom surface nozzles 40, 40a.

### EXPLANATION OF REFERENCE ALPHANUMERALS

A: Transferring Device
B: Process Chamber
B1: Door
C: Top Surface Washing Device
D: Side Surface Washing Device
E: Bottom Surface Washing Device
F: Piping Means
H to H3: Base
W: Work
1: Chain
2: Table
5: Frame
6: Main Shaft
7: Rotary Frame
7a: Side Frame
7b: Side Frame
7c: Top Frame
8: Motor
10: Transmitting Device
11: Gear
12a to 12c: Gear
14: Rotary Shaft
15: Top Surface Nozzle
15a: Top Surface Nozzle
16: Top Surface Nozzle Link
16a: Top Surface Nozzle Link
20: Side Surface Nozzle Link
20a: Side Surface Nozzle Link
21: Side Surface Nozzle
21a: Side Surface Nozzle
22 to 22b: Pulley
23: Gear
24: Gear
25: Horizontal Shaft
27: Pulley
30: Belt
35: Vertical Shaft
35a: Gear
36: Motor
37: Rotary Plate
38: Rotary Shaft
40: Bottom Surface Nozzle
40a: Bottom Surface Nozzle
41: Bottom Surface Nozzle Link
41a: Bottom Surface Nozzle Link
43: Rotary Mechanism
43a: Gear
50: Pump
50a: Compressor
51: Pipe
52: Main Pipe
53: Joint
55: Branch Pipe
56: Joint
57: First Connecting Pipe
58: Second Connecting Pipe
59: Tank
60: Joint
61: Third Connecting Pipe
62: Fourth Connecting Pipe
63: Branch Pipe
64: Joint
65: Fifth Connecting Pipe
66: Sixth Connecting Pipe
70: Drain Tank
71: Intermediate Tank
72: Work Table

What is claimed is:

1. A work washing apparatus characterized in comprising a process chamber incorporating a transferring device to carry work between a discharge position and a washing/drying position, wherein there are three different washing devices: a top surface washing device with top surface nozzles for water and air, which rotate like the sun-and-planet motion created by orbital motion and planetary motion, two side surface washing devices with side surface nozzles for water and air, which rotate like the sun-and-planet motion using orbital motion created by the orbital motion of the top surface washing device, and a bottom surface washing device with bottom surface nozzles for water and air, which rotate like the sun-and-planet motion using planetary motion and orbital motion, so as to thoroughly wash and dry the work from all directions,
the top surface washing device having;
a U-shaped rotary frame suspended from the main shaft which is provided on a main frame so as to freely rotate,
a drive means and a transmitting device to rotate the main shaft,
a rotary structure for the rotation of the main shaft, rotary shafts which are axially supported by the rotary frame supporting gears of the rotary structure and
the top surface nozzle links with a pair of nozzles provided on the rotary shafts,
thereby the rotational action of the main shaft makes the rotary frame gyrate thus causing the rotary shafts to rotate, thence making the top surface nozzle links themselves rotate,
the side surface washing devices having:
a pair of side surface nozzle links axially supported on either side of the U-shaped rotary frame,
a pair of nozzles provided on each side surface nozzle link,
a pulley provided on the axis of each side surface nozzle link,
two horizontal shafts above the rotary frame engaged to gears engaged to the rotary shafts of the side surface washing devices,
a pulley provided at either outer end of the horizontal shafts and
a belt provided on each said pulleys,
thereby the rotational action of the gyrating U-shaped rotary frame to the side surface rotary shafts is transmitted by the two horizontal shafts to each gear by the pulley provided on either outer end of the two horizontal shafts, thence to the pulleys provided on the axis of the side surface nozzle links, thus making the side surface nozzle links themselves rotate,
the bottom surface washing device having;
a vertical shaft provided on the main frame,
a rotary means for controlling the rotation of the vertical shaft,
rotary plates provided on the vertical shaft,
rotary shafts provided on the rotary plate,
bottom surface nozzle links incorporating the bottom surface nozzles and
a rotary mechanism for controlling the rotation of the rotary shafts,
thereby the rotational action of the vertical shafts is transmitted to the rotary plate, thence through the vertical shafts by the rotary mechanism, thus making the bottom surface nozzle links themselves rotate.

2. A work washing apparatus of claim 1 characterized in comprising a means for supplying water and air to each of the nozzles, the means having;
a pump and/or a compressor,
pipes extending from the pump and/or the compressor, and a main pipe being provided within the main shaft and connected to the pipes,
branch pipes being connected to the main pipe by the branch joints externally provided outside of the rotary frame,
a first and second connecting pipe connected to the branch pipe by the branch joints within each rotary shaft,
top surface nozzles provided at the end of the first and second connecting pipes,
a third and fourth connecting pipe connected to the branch pipe by the branch joints within the rotary frame,
side surface nozzles provided at the ends of the third and the fourth connecting pipes,
the branch pipes extending from the pump,
a fifth and sixth connecting pipe connected to the branch pipe by the branch joints within the vertical shaft and
bottom surface nozzles provided at the end of the fifth and the sixth connecting pipes.
